(19) United States
(12) Patent Application Publication
(10) Pub. No.: US 2020/0173808 A1
(43) Pub. Date: Jun. 4, 2020

(54) METHODS AND SYSTEMS FOR PROVIDING RECOMMENDATIONS FOR PARKING OF VEHICLES

(71) Applicant: HERE GLOBAL B.V., Eindhoven (NL)

(72) Inventors: Jerome BEAUREPAIRE, Berlin (DE); Sven KROME, New York, NY (US)

(21) Appl. No.: 16/206,267

(22) Filed: Nov. 30, 2018

(51) Int. Cl. G01C 21/36; G01C 21/34; G06Q 50/30; G06Q 10/02

(52) U.S. Cl. CPC G01C 21/3685; G01C 21/3415; G06Q 10/02; G06Q 50/30; G01C 21/3673

(57) ABSTRACT

A system, method, and computer program product may be provided for providing parking recommendations to a user. A system may include a memory configured to store computer program code instructions; and a processor configured to execute the computer program code instructions to determine relative positions between shared vehicles in vicinity of a parking location and cluster at least two shared vehicles into one or more mobility hubs based on a predefined criteria and the determined relative positions between the shared vehicles, rank the mobility hubs based on one or more hub rating parameters, and control an output interface to output parking recommendation data based on the ranking of the mobility hubs. The processor may be further configured to compute and render one or more intermodal navigation routes between the ranked mobility hubs and a destination of the user based on the parking recommendation data, on the output interface.

### TECHNOLOGICAL FIELD

The present disclosure generally relates to providing parking recommendations to users of vehicles, and more particularly relates to providing parking recommendations to a user based on mobility hubs formed from clustering of shared vehicles.

### BACKGROUND

Shared vehicle service providers typically operate in many geographical locations and may own a variety of shared vehicles corresponding to different modes of transport, for example, a shared bike, a shared scooter, a shared car, and the like. For navigating within a geographical area, these shared vehicles that belong to different modes of transport can be combined to offer new intermodal connections to the users of the shared vehicles. However, a vehicle (a personal vehicle or a shared vehicle) previously used by the user needs to be parked in vicinity of a parking location of the shared vehicle that is to be used next in an intermodal navigation route. Locations of off-street parking spots may be known well ahead in time and real time information about occupancy of such off-street parking locations also may be available. However, on-street parking is less predictable with availability of fewer parking locations and data related to occupancy of the on-street parking locations may not be accurate.

Accordingly, there is a need for providing parking recommendations near shared vehicles for parking of a vehicle to facilitate intermodal navigation by locating the next shared vehicle dynamically towards a destination of a user and avoid problems of congestion and lengthy search time in procuring suitable parking spaces.

### BRIEF SUMMARY

Existing parking assistance systems assist the users in parking a vehicle (a personal vehicle or a shared vehicle) by locating one or more parking spots in a geographical area, such as in an on-street parking area, an off-street parking area, (e.g. a garage), and the like. The parking assistance systems provide visual representation interfaces to the users comprising location markers of available off-street parking spots and/or on-street parking spots. Generally, such interfaces may be overloaded with information, such as location markers, that may confuse the users regarding the availability of suitable parking spots. Also, the information may usually be static information stored previously in a map database. However, the availability of off-street parking spots and on-street parking spots varies with time. For the users to make sense of the high density of information regarding availability of the off-street parking spots and/or on-street parking spots, a simplification in rendering the information on a display interface may be required. Thus, it would be advantageous for the users if the parking assistance systems recommend one or more parking spots based on user preferences, such as, distance between a parking location and a point of interest, etc., in a simplified and less cluttered manner. Further, the parking assistance systems may provide recommendations on parking locations dynamically based on availability of shared vehicles in an area, service boundary of service areas, intermodal connections beyond the parking location to a destination of a user, etc. It will be advantageous if the parking assistance systems may leverage an increased number of shared vehicles in a geographical region to create different possibilities to combine different modes of transport dynamically and provide intermodal solutions to the users to their desired destination.

A system, a method, and a computer program product are provided in accordance with an example embodiment described herein for providing parking recommendations to a user.

Embodiments disclosed herein may provide a system for providing parking recommendations to a user. The system may include at least one non-transitory memory configured to store computer program code instructions, and at least one processor configured to execute the computer program code instructions to at least: determine relative positions between shared vehicles in vicinity of at least one parking location and cluster at least two shared vehicles from the shared vehicles into one or more mobility hubs based on a predefined criteria and the determined relative positions between the shared vehicles, where the predefined criteria may include availability of a suitable parking location, availability of one or more bookable shared vehicles, cluster radii of the mobility hubs, user preferences regarding available shared vehicles comprising types and brands of shared vehicles, cleanliness of the shared vehicles, ratings associated with the shared vehicles, fuel level of the shared vehicles, distance to one or more available shared vehicles, and/or user subscription associated with shared vehicle service providers. The processor may be configured to execute the computer program code instructions to rank the mobility hubs based on one or more hub rating parameters, where the hub rating parameters may include a likelihood of finding at least one parking location in proximity of the mobility hubs, a distance between the parking location and the mobility hubs, an estimation of time of arrival at a destination of the user, number of alternative shared vehicles available to the user in the one more mobility hubs, matching a type of a shared vehicle in the mobility hubs with a user preferred mode of travel, a risk associated with an expiry of an allotted time of reservation of a shared vehicle in the mobility hubs, and/or cluster radii of the mobility hubs, and control an output interface to output parking recommendation data to the user for the parking location, based on the ranking of the mobility hubs, where the parking recommendation data may indicate parking options available at the parking location, estimated time of parking at the available parking location, and/or availability of at least one shared vehicle in the mobility hubs. The processor may be optionally configured to identify the parking location along a route to a destination of the user and cluster at least two shared vehicles in vicinity of the identified parking location into the mobility hubs based on service boundaries defined by shared vehicle service providers.

The processor may be further configured to compute one or more intermodal navigation routes between the ranked mobility hubs and a destination of the user based on the parking recommendation data, and render the computed intermodal navigation routes on the output interface to provide navigation assistance to the user for navigating towards the destination, where each of the intermodal navigation routes is static or dynamic. The intermodal navigation routes are dynamically computed by the processor, in cases where a mobility hub or shared vehicles in a mobility hub become unavailable. The processor may be further configured to dynamically update the cluster of at least two shared vehicles from the shared vehicles in vicinity of the parking location into one or more mobility hubs based on the predefined criteria. The processor may be further configured to dynamically update the rank of each of the dynamically updated mobility hubs based on the hub rating parameters. The processor may be further configured to render a visualization of the mobility hubs on the output interface as a list and/or location markers in a mapping application.

In an example embodiment, a method is provided for providing parking recommendations to a user that includes: determining relative positions between shared vehicles in vicinity of at least one parking location, clustering at least two shared vehicles from the shared vehicles into one or more mobility hubs based on a predefined criteria and the determined relative positions between the shared vehicles, ranking the mobility hubs based on one or more hub rating parameters, and controlling an output interface to output parking recommendation data for the parking location, based on the ranking of the mobility hubs. The parking location may be identified along a route to a destination of the user and the clustering of at least two shared vehicles in vicinity of the identified parking location into one or more mobility hubs is based on service boundaries defined by shared vehicle service providers.

The method may further include: computing one or more intermodal navigation routes between the ranked mobility hubs and a destination of the user based on the parking recommendation data, and rendering the computed intermodal navigation routes on the output interface for providing navigation assistance to the user for navigating towards the destination, where each of the intermodal navigation routes is static or dynamic. The parking recommendation data may indicate parking options available at the parking location, estimated time of parking at the available parking location, and/or availability of at least one shared vehicle in the mobility hubs. The method may further include dynamically updating the cluster of at least two shared vehicles from the shared vehicles in vicinity of the parking location into one or more mobility hubs, based on the predefined criteria. The method may further include dynamically updating the rank of each of the dynamically updated mobility hubs, by the processor, based on the hub rating parameters. The method may further include rendering a visualization of the mobility hubs, by the processor, on the output interface as one of a list and location markers in a mapping application. In an example embodiment, a method for creating mobility hubs is provided. The method may include: determining relative positions between shared vehicles, determining a distribution profile for the shared vehicles in vicinity of at least one parking location, based on the relative positions of the shared vehicles, and clustering at least two shared vehicles in vicinity of the parking location into one or more mobility hubs based on a predefined criteria and the distribution profile.

Embodiments of the present invention may provide a computer program product including at least one non-transitory computer-readable storage medium having computer-executable program code instructions stored therein. The computer-executable program code instructions when executed by a computer, cause the computer to carry out operations for providing on-street parking predictions, the operations including: determining relative positions between shared vehicles in vicinity of at least one parking location, clustering at least two shared vehicles from the shared vehicles into one or more mobility hubs based on a predefined criteria and determined relative positions between the shared vehicles, ranking of the mobility hubs based on one or more hub rating parameters, and controlling an output interface to output parking recommendation data for the parking location, based on the ranking of the mobility hubs.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a schematic diagram of a system for providing parking recommendations to a user, in accordance with an example embodiment;

FIG. 2 illustrates a block diagram of another embodiment of a system for providing parking recommendations to a user, in accordance with an example embodiment;

FIG. 3 illustrates a block diagram of a mapping platform exemplarily illustrated in FIG. 2 that may be used to provide parking recommendations to a user, in accordance with an example embodiment;

FIG. 4 exemplarily illustrates a method for providing parking recommendations to a user, in accordance with an example embodiment;

FIG. 5 exemplarily illustrates a flow diagram of a method comprising steps for clustering shared vehicles into one or more mobility hubs, in accordance with an example embodiment;

FIG. 6 exemplarily illustrates a flow diagram of a method comprising steps for clustering shared vehicles into one or more mobility hubs based on parking locations, in accordance with an example embodiment;

FIG. 7 exemplarily illustrates a flow diagram of a method comprising steps for suggesting intermodal navigation routes to a user, in accordance with an example embodiment; and

FIG. 8 exemplarily illustrates a user interface showing an intermodal navigation route computed by the mapping platform, in accordance with an example embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present invention. Thus, use of any such terms should not be taken to limit the spirit and scope of embodiments of the present invention.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Definitions

The term “link” may be used to refer to any connecting pathway including but not limited to a roadway, a highway, a freeway, an expressway, a lane, a street path, a road, an alley, a controlled access roadway, a free access roadway and the like.

The term “mobility hub” may be used to refer to an aggregation of shared vehicles at a location in a geographical region, which supports intermodal navigation.

The term “parking recommendations” may be used to refer to recommendations associated with parking of a vehicle (may be a personal vehicle or a shared vehicle) in vicinity of a mobility hub including but not limited to availability of parking spots, parking options at the available parking spots, and the like.

The term “service boundary” may be used to refer to a virtual perimeter of a service area defined by a shared vehicle service provider that defines a geographical region catered by a shared vehicle service provider. The service boundary may alternately define the geographical region as bounded by a geometrical shape such as a polygon shape; a circle; a shape delimited by road segments; a geo-fence, and the like.

### End of Definitions

A method, a system, and a computer program product are provided herein in accordance with an example embodiment for providing parking recommendations to users. One or more shared vehicle service providers may own shared vehicles that may be used by the users to navigate to their desired destinations. The shared vehicle service providers may employ a parking assistance system to provide parking recommendations for picking up or parking of the shared vehicles by the users. The shared vehicle service providers may also provide recommendations related to one or more intermodal navigation routes to a destination of a user from at least one parking location. Existing parking assistance systems, for example, Park and Ride provide combinations of transport modes from a known dedicated off-street parking spot that has connectivity to a public transport network. However, the intermodal connections suggested by the existing parking assistance systems are static. The existing parking systems only provide intermodal connectivity between a parking spot of a vehicle (a shared vehicle or a personal vehicle) and a public transport, details of both are previously stored in a database, for example, a map database. There is a need for method and a system for providing parking recommendations and intermodal navigation routes to the users to destinations of the users dynamically, taking advantage of availability of an increased number of shared vehicles operated by numerous shared vehicle service providers within a geographical region. The availability of on-street parking locations in a geographical region varies and sometimes, user preferences for the modes of transport in the intermodal navigation routes may vary. A method and a system that supports dynamic re-routing of the user based on his/her preferences and availability of on-street parking locations may also be needed.

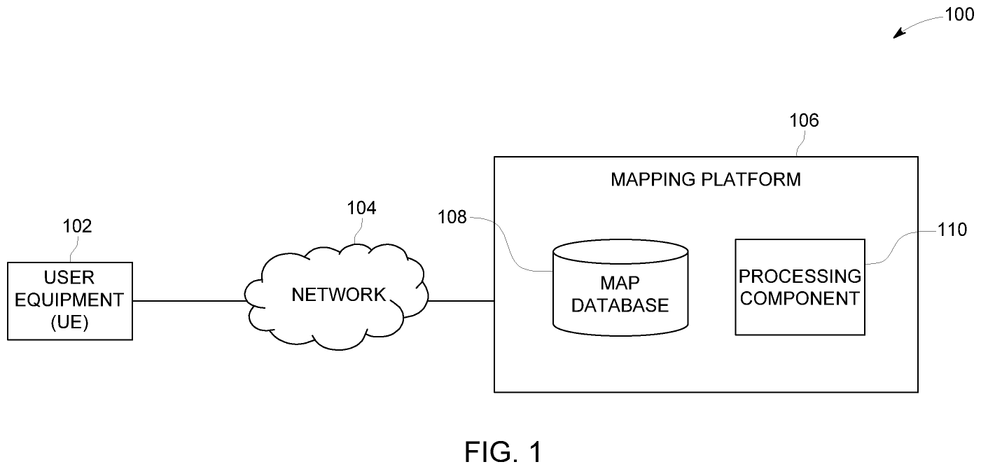

FIG. 1 exemplarily illustrates a schematic diagram of a system 100 that employs a dynamic approach in providing parking recommendations to a user for implementing example embodiments described herein. The system 100 includes a user equipment (UE) or a user device 102, which may be in communication with a mapping platform 106, over a network 104. The network 104 may be wired, wireless, or any combination of wired and wireless communication networks, such as cellular, Wi-Fi, internet, local area networks, or the like. The user equipment 102 may be an in-vehicle navigation system, such as an infotainment system, a personal navigation device (PND), a portable navigation device, a cellular telephone, a smart phone, a personal digital assistant (PDA), a watch, a camera, a computer, a workstation, and/or other device that can perform navigation-related functions, such as digital routing and map display. An end user can use the user equipment for navigation and map functions such as guidance and map display, for example, and for determination of one or more personalized routes or route segments based on one or more calculated and recorded routes, according to some example embodiments. In some example embodiments, the user equipment 102 may be configured to provide route guidance and navigation related functions to the user of a vehicle, a personal vehicle or a shared vehicle. The user may drive a shared vehicle that may be rented out by a shared vehicle service provider. In an embodiment, the user may use a personal vehicle for a first leg of a route towards his/her destination and the user may use one or more shared vehicles rented out by one or more shared vehicle service providers for remaining of the route toward the destination. In an embodiment, the user may use one or more shared vehicles for a first leg of a route towards his/her destination and the user may use a personal vehicle for a final leg of the route towards the destination. In some embodiments, the user may use a combination of one or more personal vehicles and one or more shared vehicles based on his/her preferences on a route towards the destination of the user. The parking recommendations provided by the system 100 may be transmitted to the user. In some embodiments, the parking recommendations provided by the system 100 may be transmitted to the shared vehicle service provider and the shared vehicle service provider may provide parking related recommendations to the user of the shared vehicle. In some embodiments, the user equipment 102 may be installed in the vehicle and may be configured to provide parking recommendations to the user. The user equipment 102 may also include an image capturing device, such as a camera.

The user equipment 102 may include a mobile computing device such as a laptop computer, tablet computer, mobile phone, smart phone, navigation unit, personal data assistant, watch, camera, or the like. Additionally or alternatively, the user equipment 102 may be a fixed computing device, such as a personal computer, computer workstation, kiosk, office terminal computer or system, or the like. The user equipment 102 may be configured to access the mapping platform 106 via a processing component 110 through, for example, a user interface of a mapping application, such that the user equipment 102 may provide parking and navigational assistance to the user among other services provided through access to the mapping platform 106.

As exemplarily illustrated, the mapping platform 106 may also include a map database 108, which may include node data, road segment data or link data, point of interest (POI) data, posted signs related data or the like. The map database 108 may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, for example, cars, trucks, buses, motorcycles, and/or other entities. Optionally, the map database 108 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 108 can include data about the POIs and their respective locations in the POI records. The map database 108 may additionally include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 108 can include event data (e.g., traffic incidents, construction activities, scheduled events, unscheduled events, etc.) associated with the POI data records or other records of the map database 108 associated with the mapping platform 106. The map database 108 may additionally include types of shared vehicles, brands of shared vehicles, directory of different shared vehicle service providers, data related to service boundaries catered by the different shared vehicle service providers, location of off-street parking spots, capacity of the off-street parking spots, parking options available at the off-street parking spots, data about traffic regulations, speed limits, posted traffic signs, posted speed limit signs, heading data and the like. In some example embodiments, the map database 108 may additionally include navigation routes within a service boundary, intermodal connections available within a service boundary, parking options at on-street parking spots within a service boundary, etc.

A content provider such as a map developer may maintain the mapping platform 106. In some example embodiments, a shared vehicle service provider may have access to the mapping platform 106 for accessing and/or publishing location-related data associated to availability of shared vehicles, types and brands of the available shared vehicles, location of mobility hubs, intermodal connections available from mobility hubs, etc. By way of example, the map developer can collect geographic data to generate and enhance the mapping platform 106. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Crowdsourcing of geographic map data can also be employed to generate, substantiate, or update map data. For example, sensor data from a plurality of data probes, which may be, for example, vehicles traveling along a road network or within a venue, may be gathered and fused to infer an accurate map of an environment in which the data probes are moving. Such sensor data may be updated in real time such as on an hourly basis, to provide accurate and up to date map data. The sensor data may be from any sensor that can inform a map database of features within an environment that are appropriate for mapping. For example, motion sensors, inertia sensors, image capture sensors, proximity sensors, LIDAR (light detection and ranging) sensors, ultrasonic sensors etc. The gathering of large quantities of crowd-sourced data may facilitate the accurate modeling and mapping of an environment, whether it is a road segment or the interior of a multi-level parking structure. Also, remote sensing, such as aerial or satellite photography, can be used to generate map geometries directly or through machine learning as described herein.

The map database 108 of the mapping platform 106 may be a master map database stored in a format that facilitates updating, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the user equipment 102, for example. Further, data may be compiled relating to parking space availability along different road segments within a service area defined in the map database 108, where a parking availability estimation may be generated in dependence of time of day, day of week, season of the year, special events, service boundaries of the other shared vehicle service providers, etc. The navigation-related functions can correspond to vehicle navigation, pedestrian navigation, navigation to a favored parking spot or other types of navigation. While example embodiments described herein generally relate to vehicular travel and parking along roads, example embodiments may be implemented for bicycle travel along bike paths and bike rack/parking availability, boat travel along maritime navigational routes including dock or boat slip availability, off-street parking of vehicles, etc. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

In some embodiments, the mapping platform 106 may be a master geographic database configured at a server side, but in alternate embodiments, a client side mapping platform 106 may represent a compiled navigation database that may be used in or with end user devices (e.g., user equipment 102) to provide navigation, speed adjustment and/or map-related functions. For example, the mapping platform 106 may be used with the end user device, that is, the user equipment 102 to provide the user with navigation features. In such a case, the mapping platform 106 can be downloaded or stored on the user equipment 102 which can access the mapping platform 106 through a wireless or a wired connection, over the network 104.

In one embodiment, the user device or the user equipment 102 can be used to perform navigation-related functions, such as digital routing and map display. A user may be recommended by the mapping platform 106 on a user interface of the user equipment 102 about intermodal navigation routes to the destination of the user, availability of mobility hubs en route the destination, availability of at least one parking spot in the vicinity of the mobility hubs. In some example embodiments, the user may be navigating to a destination that may be a defined location with an address, a Point of Interest (POI), an area of a city, a restricted transit area (for example, no parking, only electric vehicle, no diesel vehicle area, etc.) or a destination of the above inside the restricted transit area. The user may be notified about availability of parking spots in the road links within the service boundaries, parking estimation times in the available parking spots in the road links, parking options in the available parking spots, and the like. The user equipment 102 may allow performing a reservation of a shared vehicle rented out by a shared vehicle service provider prior to using the shared vehicle. The shared vehicle service provider may be notified by the mapping platform 106 about reservation of the shared vehicle by the user, about start of allotted time of reservation of the shared vehicle, and about parking of the shared vehicle at a parking spot in the vicinity of a mobility hub by the user. In some embodiments, the user of the vehicle, a shared vehicle or a personal vehicle, may use the user equipment 102, for example, the in-vehicle navigation system for navigation and map functions such as guidance and map display, for example, of navigation routes in search of parking spots individually, according to some example embodiments. The user equipment 102 may include an application, for example, a mapping application with a user interface that may enable the user to access the mapping platform 106 for availing the functions disclosed above.

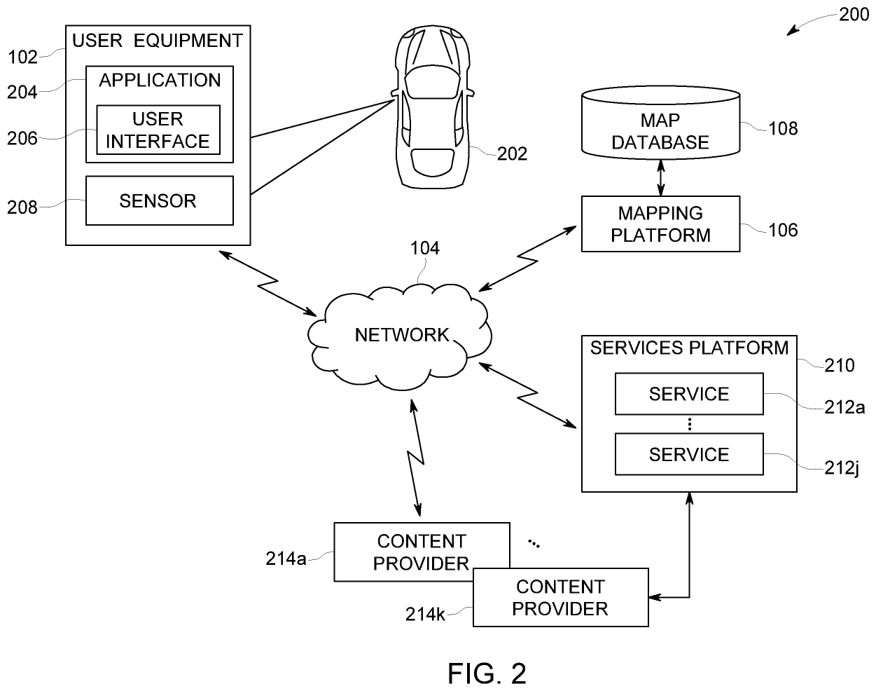

FIG. 2 exemplarily illustrates a block diagram of another embodiment of a system 200 for providing parking recommendations to a user for assisting in parking and navigation of a vehicle 202 using a mapping platform 106. The vehicle 202 may be a personal vehicle owned by the user or a shared vehicle rented by the user from a shared vehicle service provider. The system 200 includes a user equipment 102, including an application 204 with a user interface 206 for accessing one or more map and navigation related functions. The user equipment 102 may also include one or more sensors 208 such as a camera, an acceleration sensor, a gyroscopic sensor, a LIDAR sensor, a proximity sensor, a motion sensor and the like. The sensors 208 may, primarily be, for determining position of the vehicle 202 and the sensors 208 may be built-in or embedded into or within interior of the user equipment 102. In some embodiments, the user equipment 102 uses communication signals for position determination. The user equipment 102 may receive location data from a positioning system, a Global Navigation Satellite System (GNSS), such as a Global Positioning System (GPS), Galileo, Globalnaya Navigazionnaya Sputnikovaya Sistema (GLONASS), BeiDou Navigation Satellite System (BDS), etc., cellular tower location methods, access point communication fingerprinting, such as Wi-Fi/Bluetooth based radio maps, or the like. The data collected by the sensors 208 may be used to gather information related to an environment of the vehicle 202. The environment of the vehicle 202 may include other shared vehicles in use or located at a parking spot. In some embodiments, the vehicle 202 may have sensors positioned on or within and the sensors may provide data indicating a location of the vehicle 202. Vehicle data, also referred to herein as “probe data”, may be collected by any device capable of determining the necessary information, and providing the necessary information to a remote entity. The user equipment 102 is one example of a device that can function as a probe to collect probe data of the vehicle 202.

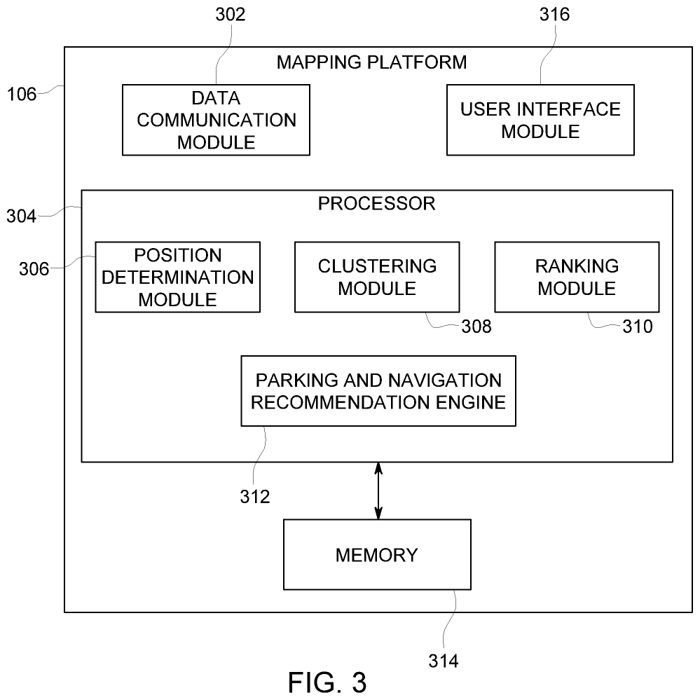

More specifically, probe data collected by the user equipment 102 may be representative of the location of the vehicle 202 at a respective point in time and may be collected while the vehicle 202 is traveling along a route. While probe data is described herein as being vehicle probe data, example embodiments may be implemented with pedestrian probe data, marine vehicle probe data, or non-motorized vehicle probe data (e.g., from bicycles, skate boards, horseback, etc.). According to the example embodiment described below with the probe data being from motorized vehicles traveling along roadways, the probe data may include, without limitation, location data, (e.g. a latitudinal, longitudinal position, and/or height, GNSS coordinates, proximity readings associated with a radio frequency identification (RFID) tag, or the like), rate of travel, (e.g. speed), direction of travel, (e.g. heading, cardinal direction, or the like), device identifier, (e.g. vehicle identifier, user identifier, or the like), a time stamp associated with the data collection, or the like. The user equipment 102, may be any device capable of collecting the aforementioned probe data. In one example, sensors may also be installed at the parking spots and on the road links within a service area defined by a service boundary. The sensors installed at the parking spots and on the road links may serve to control traffic, determine on-street parking availability, facilitate speed control of the vehicles, and the like. The sensors installed in the shared vehicles or in the user equipment in the shared vehicles may transmit the sensor data to one or more shared vehicle service providers operating the shared vehicles. The sensors, such as, GNSS based sensors in a shared vehicle, may report location of the shared vehicle via wireless or cellular networks to a shared vehicle service provider to whom the shared vehicle belongs. The mapping platform 106 may query the shared vehicle service providers via an API to determine locations of the shared vehicles available at any given time. Using the location data from the user equipment 102 of the vehicle and the queried location data from the shared vehicle service providers, the mapping platform 106 may create spatial clusters of the available shared vehicles. The mapping platform 106, further may filter the aggregations of the available shared vehicles based on generic or personalized criteria and generates parking recommendations to assist the vehicle 202 to park in an available on-street parking spot or off-street parking spot in the vicinity of a mobility hub and proceed further towards a destination using a shared vehicle of his/her choice from a mobility hub. In an embodiment, multiple shared vehicles in a mobility hub may be co-located at a location within a geographical region. In some example embodiments, where shared vehicles in a mobility hub are within a cluster radius, there is no major physical border, such as, a river or any physical element, between the shared vehicles of the mobility hub. In this embodiment, the user can move from a shared vehicle in a mobility hub to another shared vehicle in the mobility hub easily without limitation on the mode of transport that is being used. Furthermore, the user can move from a first mobility hub to a second mobility hub due to non-availability of a shared vehicle in the first mobility hub without hindrance. The processing of the sensor data to generate the parking recommendations may be performed by the processor 304 including multiple modules 306, 308, 310, and 312 of the mapping platform 106 exemplarily illustrated in FIG. 3. The processor 304 is similar to a processing component 110 exemplarily illustrated in FIG. 1.

The system 200 may further include a services platform 210, which may be used to provide navigation related functions and services 212a-212i to the application 204 running on the user equipment 102. The services 212a-212i may include such as navigation functions, speed adjustment functions, traffic related updates, weather related updates, warnings and alerts, parking related services, in particular on-street or off-street parking availability services, indoor mapping services, and the like. The services 212a-212i may be provided by a plurality of content providers 214a-214k. In some examples, the content providers 214a-214k may access various APIs from the services platform 210 for implementing one or more services. In an example, the services platform 210 and the mapping platform 106 may be integrated into a single platform to provide a suite of mapping and navigation related applications for OEM devices, such as the user equipment 102. The user equipment 102 may be configured to interface with the services platform 210, the content provider's services 214a-214k, and the mapping platform 106 over a network 104. Thus, the mapping platform 106 and the services platform 210 may enable provision of cloud-based services for the user equipment 102, such as, for providing parking recommendations to the user of the vehicle 202 carrying the user equipment 102.

FIG. 3 exemplarily illustrates a block diagram of the mapping platform 106 that may be used to provide parking recommendations to a user in accordance with an example embodiment of the present invention. In the embodiments described herein, the mapping platform 106 comprises a data communication module 302, a position determination module 306, a clustering module 308, a ranking module 310, a parking and navigation recommendation engine 312, and a user interface module 316. In this embodiment exemplarily illustrated in FIG. 3, the position determination module 306, the clustering module 308, the ranking module 310, and the parking and navigation recommendation engine 312 are embodied within the processor 304. The processor 304 may retrieve computer program code instructions that may be stored in a memory 314 for execution of the computer program code instructions by the modules 302, 306, 308, 310, and 312 of the mapping platform 106. The processor may control the execution of the computer program code instructions by the modules 302, 306, 308, 310, and 312 of the mapping platform 106. In one embodiment, the data communication module 302 communicates with the sensors 208 disclosed in the detailed description of FIG. 2 and receives the sensor data, that is, location data of the vehicle 202 from the sensors 208 and location data of other shared vehicles, from the shared vehicle service providers.

In an embodiment, the sensors may be installed at different locations in the road links and at garages, multi-story parking lots, underground parking lots, etc., and the sensors may periodically transmit parking availability data, traffic data, etc., to the mapping platform 106 over the network 104. In some embodiments, the sensors may be installed at the service boundary of a service area of a shared vehicle service provider and the sensors periodically transmit data related to the service boundary to the mapping platform 106 over the network 104. The service area catered by a shared vehicle service provider may be of various shapes, for example, a polygon shape, a circle, etc. In one example, the shape of the service area may be defined by road links. In other examples, the shape of the service area may be defined virtually by a geo-fence created by the shared vehicle service provider in their area of interest.

In some example embodiments, the data communication module 302 may also receive location of on-street parking spots in real-time from sensors installed at the parking spots on the road links. The data communication module 302 may fetch locations of off-street parking spots stored in the map database 108. The data communication module 302 may also receive information related to destination of a user of the parking recommendation system via the network 104. The destination of a user may be a location with a corresponding address, a point of interest, such as, school, mall, etc., an area in a geographical region, a restricted transit area or zone, such as, a no parking zone, only electric vehicle zone, no diesel zone, a destination within the restricted transit area, and the like. The data communication module 302 may also receive subscription details associated with different shared vehicle service providers from the user. The user may subscribe to one or more shared vehicle service providers. In some example embodiments, the user may be provided with some additional privileges by one or more shared vehicle service providers on the subscription. The data communication module 302 may receive user preferences from the user of the vehicle 202 regarding type of shared vehicles preferred, preferred brand of shared vehicle service provider, type of shared vehicles preferred for a selected distance, and brands of shared vehicles preferred. The data communication module 302 may suggest types of shared vehicles and brands of shared vehicles, and the user may be allowed to select from the suggested shared vehicles on the user interface 206. The user may select regular bikes over e-bikes, scooters over rollers based on their preferences. Similarly, the user may select a roller for a distance less than 2 kilometers (kms), then bikes until a distance of 4 km, and then scooters based on their preferences. Similarly, the user may be allowed to select a preferred shared bike service provider over other shared bike service providers. Similarly, the user may be allowed to select a preferred brand of bikes. The data communication module 302 also receives a number of shared vehicles that the user desires to be clustered into a mobility hub. The data communication module, as a part of sensor data, also receives fuel level of the shared vehicles.

In some embodiments, the data communication module 302 may receive battery levels of electric shared vehicles. In some embodiments, the data communication module 302 receives a value for fuel level or battery level desired in a shared vehicle from a user based on the distance the shared vehicle intends to cover using the shared vehicle. In some embodiments, the user is allowed to rank the mobility hubs based on match between the user preferences and the attributes and services provided by the mobility hubs. In such embodiments, the data communication module 302 may also receive the ranks for the mobility hubs from the user. In an embodiment, the data communication module 302 receives cluster radius of a mobility hub to be formed from the user. Cluster radius refers to distance between a parking spot in the vicinity of the mobility hub and farthest of the shared vehicles to be clustered into the mobility hub. A smaller cluster radius indicates that at least one shared vehicle is available in proximity of the parking spot. The cluster radius may be set by a predetermined distance specified by the user via the user equipment 102, or by the mapping platform 106. The cluster radius may also be determined from learnt walking patterns of the user, i.e. a distance that the user finds acceptable to walk. The user may input the cluster radius to be less than, for example, 200 meters. That is, in the mobility hub, the shared vehicles may be located within a distance of 200 meters from the parking spot. The data communication module 302 may receive desired cleanliness levels in the shared vehicles from the user. The data communication module 302 may also receive ratings associated with the shared vehicles provided by other users. In some example embodiments, the data communication module 302 may receive ratings for a shared vehicle from the user after usage of the shared vehicle.

Parking assistance systems, for example, ParkNav® of AI Incube Inc. or Parkopedia® of ETCM Ltd., provide parking availability prediction services. The parking assistance systems may employ prediction models to render predictions on availability of parking spots for each link within a geographical area. The data communication module 302 may also receive parking spot availability data at a point in time on querying the parking assistance systems via an API. The data communication module 302 may receive number of shared vehicles available in a service area at a point in time from the shared vehicle service providers. The position determination module 306 embodied in the processor 304 may determine relative positions between the shared vehicles in the vicinity of at least one parking location, that is, an on-street parking spot or an off-street parking spots using the sensor data received from the shared vehicle service providers and parking availability data from the parking assistance systems. The position determination module 306 computes the relative positions between the vehicle 202, personal vehicle or shared vehicle of the user and other shared vehicles and the relative positions between the shared vehicles and parking spots using the location data of the shared vehicles and the parking spots. The position determination module 306 may determine the relative positions of the shared vehicles using beacons, GPS co-ordinates of the shared vehicles, etc. The positions and availability of the shared vehicles are obtained from the shared vehicle service providers through their own APIs, as the shared vehicles report their locations and the shared vehicle service providers manage availability of the shared vehicles. The position determination module 306 may select a set of relevant shared vehicles from the shared vehicles in the vicinity, within a predetermined or user defined range, to on-street parking facilities or off-street parking facilities that are marked available by a parking assistance system. The position determination module 306 may determine a distance of the selected set of shared vehicles from a next available parking position.

In an example embodiment, the position determination module 306 may generate a distribution profile of the shared vehicles around a parking spot after computing the relative positions of the shared vehicles. In an embodiment, the position determination module 306 identifies at least one parking location to cluster shared vehicles in the vicinity, along a route to the destination of the user. In an embodiment, the position determination module 306 determines position of the shared vehicles relative to the destination of a user. The position determination module 306 may also determine whether destination of the user is within at a service boundary of at least one shared vehicle service provider. The position determination module 306 may be in communication with the clustering module 308.

The clustering module 308 embodied in the processor 304 may cluster at least two shared vehicles into one or more mobility hubs based on a predefined criteria and the determined relative positions between the shared vehicles. The clustering module 308 may communicate with the data communication module 302 to query the parking assistance system for available parking spots. Around a parking spot, the clustering module 308 may search for a combination of shared vehicles based on the predefined criteria. The user preferences received by the data communication module 302 may constitute the predefined criteria. The clustering module 308 may search for, for example, 4 bikes, 4 scooters, and 4 rollers, in the vicinity of a parking spot based on user preferences. The clustering module 308 may, further, determine cluster radius of a mobility hub to be formed from the relative positions of the shared vehicles. The clustering module 308 may cluster the shared vehicles that satisfy the cluster radii defined by the user. In some embodiments, the clustering module 308 may cluster the shared vehicles that satisfy the cluster radii defined by the parking and navigation recommendation engine 312. In some example embodiments, the clustering module 308 may cluster the shared vehicles in the vicinity of a parking spot based on a service boundary defined by at least one shared vehicle service provider. In these example embodiments, the clustering module 308 clusters the shared vehicles only when the destination of the user is within the service boundary of at least one shared vehicle service provider. In this manner, the clustering module 308 does not merely bundle the shared vehicles into mobility hubs.

The clustering module 308 may cluster the shared vehicles within a predetermined range of the destination of the user, that is, the clustering module 308 may cluster the shared vehicles that can cater to reaching the destination via a shortest path, for reaching the destination via a fastest path, etc. The clustering module 308 may cluster the shared vehicles based one or more of user preferences received by the data communication module 302. In an embodiment, the clustering module 308 may cluster the shared vehicles into one or more mobility hubs based on historical user preferences. The clustering module 308 may, further, search for shared vehicles that are bookable since the user of the mobility hub may want to secure a shared vehicle at the start of his/her journey towards a destination. The user preferences constitute the personalized criteria to form mobility hubs. The predefined criteria may also be a generalized criteria based on zoning within service boundaries, availability of parking spots in the vicinity of the mobility hub to be formed, time of day, weather conditions, etc. For example, if navigation route to a destination of the user passes via a bike only zone, the clustering module 308 clusters only shared bikes within the bike only zone irrespective of the user preferences. Consider an example of finding a parking spot (an on-street parking spot or an off-street parking spot) for a shared car in a business district. On a working day and during the working hours of businesses, it can be difficult to find a parking spot. In such a scenario, the clustering module 308 may cluster bikes, scooters, etc., to form mobility hubs in the vicinity of the business district since viability of finding a parking spot for a bike is relatively high. The clustering module 308, in an embodiment, may update the cluster dynamically based on changes in the predefined criteria, mainly, the user preferences.

The ranking module 310 embodied within the processor 304 may rank one or more mobility hubs based on one or more hub rating parameters. The hub rating parameters may gauge the quality of services provided by a mobility hub to the user. In some embodiments, the ranking module 310 may rank the mobility hub based on likelihood of finding a parking spot in the vicinity of the mobility hub, estimated time of arrival of the user at a destination on using the mobility hub, distance between the parking spot and the shared vehicle in the mobility hub, and fit of the mobility hub with the user preferences. In some embodiments, the ranking module 310 may rank the mobility hub based on the number of alternative shared vehicles available to the user at the location of the mobility hub, thereby reducing a risk of finding a broken vehicle on arrival at the mobility hub, and a risk to have a reservation of a shared vehicle with a shared vehicle service provider expired, based on traffic conditions or difficulties to find parking spot in the vicinity of the mobility hub. In some embodiments, the ranking module 310 may rank a mobility hub based on a minimum number of available shared vehicles of a given type, in cases where the user of a personal vehicle or a shared vehicle may be accompanied by other users who may also require an available shared vehicle at the mobility hub. A minimum number of available shared vehicles may be determined using the occupancy sensors in the personal vehicle or the shared vehicle. For example, three passengers arriving in a single personal car to a mobility hub may require three rental bicycles to continue with the journey to the final destination and the ranking module 310 may rank the mobility hub based on the availability of three rental bicycles of preferred brands and preferred bicycle rental service providers to the three passengers. In some example embodiments, the ranking module 310 may rank the mobility hub based on cluster radius of the mobility hub for the applied demand and convenience of use of the mobility hub. The ranking module 310 may rank multiple mobility hubs in a geographical region based on match with preferences of a user. A high ranked mobility hub is a mobility hub that has a maximum match to the user preferences. The ranking module 310 may generate a list of the rankings of the mobility hubs. In some embodiments, the ranking module 310 may rank the mobility hubs based on expiry of an allotted time of reservation of an off-street parking spot. The ranking module 310 may, in some example embodiment, dynamically update the rank of a dynamically updated mobility hub based on the hub rating parameters. In some example embodiments, the ranking module 310 may compare the ranks provided by the user with the ranks provided by the ranking module 310 and may award final ranks to the mobility hubs. In some example embodiments, the ranking module 310 may rank or rate a user of the shared vehicle based on his interactions with the shared vehicle and the mapping platform 106. In such embodiments, based on the ranks, the parking and navigation recommendation engine 312 may recommend the shared vehicle service providers to award some privileges, such as, discounts in rental charges of the shared vehicles, allowance in reservation period of a shared vehicle, etc., to the user of the shared vehicle.

The parking and navigation recommendation engine 312 embodied within the processor 304 may generate parking recommendations to park the vehicle 202 (a personal vehicle or a shared vehicle) at a parking spot in the vicinity of a high ranked mobility hub. In an embodiment, the parking and navigation recommendation engine 312 may generate parking recommendations to park a personal vehicle at a parking spot (an on-street parking spot or an off-street parking spot) in the vicinity of a high ranked mobility hub. The parking and navigation recommendation engine 312 generates parking recommendation data that may include parking options available the parking spot, estimated time of parking at the available parking spot, availability of a shared vehicle in the mobility hubs in the vicinity of the parking spot, etc. The parking and navigation recommendation engine 312 may suggest a user using a personal vehicle to park his/her personal vehicle in the vicinity of a mobility hub and continue beyond using a shared vehicle from the mobility hub. In an embodiment, where the vehicle 202 is a bike or a scooter, the bike or the scooter can be parked at the mobility hub and another shared vehicle can be accessed from the same mobility hub. In such embodiments, the parking and navigation recommendation engine 312 may guide the user of the bike or the scooter in parking the bike or the scooter at the mobility hub itself and suggest him/her to access a shared vehicle from the mobility hub of his/her personal choice. In embodiments where the vehicle 202 is a car, the parking and navigation recommendation engine 312 may guide the user of the car (a personal car or a shared car) to park the car in a parking spot and navigate, for example, by walking towards a shared vehicle in the mobility hub. In some example embodiments, the parking and navigation recommendation engine 312 may compute one or more intermodal navigation routes between the ranked mobility hubs and a destination of the user, based on the parking recommendation data. The parking and navigation recommendation engine 312 may compute static intermodal navigation routes. In an embodiment, the parking and navigation recommendation engine 312 may alter the computed intermodal navigation routes dynamically based on the updated location and/or rankings of the mobility hubs. The parking and navigation recommendation engine 312 may recommend one or more intermodal navigation routes to the destination of the user taking advantage of the personalized mobility hubs. The parking and navigation recommendation engine 312 helps the user to select a most suitable intermodal navigation route from the recommended intermodal navigation routes. The intermodal navigation routes may include a navigation route to a parking spot, navigation route (by walk) from the parking spot to a shared vehicle in a mobility hub, navigation route using the shared vehicle to a parking spot in the vicinity of another mobility hub along the route to the destination of the user, navigation route (by walk or a personal vehicle) from the parking spot to the destination, and variations thereof. In an embodiment, the shared vehicle service providers own, or lease a number of reserved parking spaces or areas, especially in busy areas, such as business districts. The parking and navigation recommendation engine 312 of the mapping platform 106 considers locations and availability of the reserved parking spaces in the case of unavailability of public parking spots (on-street parking spots or off-street parking spots).

In some example embodiments, a user may be driving towards a mobility hub and, while the user is still in transit, likelihood of finding an on-street parking spot in the vicinity of the mobility hub, availability of an off-street parking spot in the vicinity of the mobility hub, and/or availability of shared vehicles at the mobility hub may change. In such a scenario, the parking and navigation recommendation engine 312 may be configured to dynamically compute an intermodal navigation route towards the destination of the user via a next high ranked mobility hub. The parking and navigation recommendation engine 312 may recommend the computed alternative navigation routes for the user to select. In some example embodiments, the parking and navigation recommendation engine 312 may select an alternative or second best intermodal navigation route and dynamically re-route the user towards his/her destination. In cases the user is using a personal vehicle to navigate to the destination and the user had previously subscribed to services of one or more shared vehicle service providers, the parking and navigation recommendation engine 312 may suggest the user to change to a shared vehicle and navigate to the destination leveraging mobility hubs en-route. The parking and navigation recommendation engine 312 may provide the user of the personal vehicle with the incentives he/she gains on changing to a shared vehicle beyond a point in the journey. The parking and navigation recommendation engine 312 may receive the locations of the dynamically formed mobility hubs from the clustering module 308 to generate the parking recommendation data and the intermodal navigation routes. In some example embodiments, the parking and navigation recommendation engine 312 may use on-street parking prediction models, for example, statistical models, machine learning models, etc., to determine availability of on-street parking locations to generate the parking recommendation data and the intermodal navigation routes. The parking and navigation recommendation engine 312 may also receive the destination of the user and location and attributes of the vehicle 202 (the personal vehicle or the shared vehicle) from the data communication module 302 to generate the parking recommendation data and compute the intermodal navigation routes. The parking and navigation recommendation engine 312 may also receive location of off-street parking spots from the map database 108 and availability of off-street parking spots from the data communication module 302 to generate the parking recommendation data and compute the intermodal navigation routes. In an embodiment, the parking and navigation recommendation engine 312 may recommend the user with intermodal navigation routes based on availability of public transport or last mile connectivity of the destination of the user from a mobility hub.

The user interface module 316 may render the generated parking recommendation data and/or intermodal navigation routes on the user interface 206 of the user equipment 102. In an embodiment, when the parking recommendation data and the intermodal navigation routes are updated by the parking and navigation recommendation engine 312, the user interface module 316 may update the rendered on-street parking recommendation data and/or intermodal navigation routes. The user interface module 316 controls the user interface 206 to output parking recommendation data to user for one or more parking spots. The user interface module 316 may render a visualization of the formed mobility hubs on the user interface 206 as a list, location markers in the user interface 206 of a mapping application in an intermodal navigation route, and a combination thereof. The different visualizations of the parking recommendations may be in the form of a map of the service area with color coded or patterned road links and parking spots, a list of street segments or road links where parking spots are available, a tabular representation of the likelihood of finding a parking spot in different road links in a service area, available parking spots in the road links, estimated time for parking the vehicle 202 in the available parking spots, an indication of probability of finding a parking spot, etc. In an embodiment, the user interface module 316 may receive the user preferences from the user on the user interface 206 of the user equipment 102. The user interface module 316 may receive destination information of the user from the user on the user interface 206 of the user equipment 102. The user interface module 316 may receive a selection of intermodal navigation route from the user from a list of recommended intermodal navigation routes on the user interface 206 of the user equipment 102. The user interface module 316 may receive ranks associated with the mobility hubs from the user on the user interface 206 of the user equipment 102. In some example embodiments, the user interface module 316 may receive a request for reservation or booking for a shared vehicle at an approaching mobility hub on the user interface 206 of the user equipment 102. The user interface module 316 may notify the user via the user interface 206 of the user equipment 102 about upcoming reservation of a shared vehicle at an approaching mobility hub. In some example embodiments, the user interface module 316 renders the parking recommendation data, in mobile applications or navigation applications used by the users. The user interface module 316 may be configured to update the rendered recommendations on receiving control instructions from the processor 304.

The processor 304 may be embodied in a number of different ways. For example, the processor 304 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 304 may include one or more processing cores configured to perform independently. A multi-core processor may enable multiprocessing within a single physical package. Additionally or alternatively, the processor 304 may include one or more processors configured in tandem via the bus to enable independent execution of instructions, pipelining and/or multithreading. Additionally or alternatively, the processor 304 may include one or processors capable of processing large volumes of workloads and operations to provide support for big data analysis.

In an example embodiment, the processor 304 may be in communication with a memory 314 via a bus for passing information among components of the system 200. The memory 314 may be non-transitory and may include, for example, one or more volatile and/or non-volatile memories. In other words, for example, the memory 314 may be an electronic storage device (for example, a computer readable storage medium) comprising gates configured to store data (for example, bits) that may be retrievable by a machine (for example, a computing device like the processor 304). The memory 314 may be configured to store information, data, content, applications, instructions, or the like, for enabling the apparatus to carry out various functions in accordance with an example embodiment of the present invention. For example, the memory 314 could be configured to buffer input data for processing by the processor 304. As exemplarily illustrated in FIG. 3, the memory 314 could be configured to store instructions for execution by the processor 304. As such, whether configured by hardware or software methods, or by a combination thereof, the processor 304 may represent an entity (for example, physically embodied in circuitry) capable of performing operations according to an embodiment of the present invention while configured accordingly. Thus, for example, when the processor 304 is embodied as an ASIC, FPGA or the like, the processor 304 may be specifically configured hardware for conducting the operations described herein. Alternatively, as another example, when the processor 304 is embodied as an executor of software instructions, the instructions may specifically configure the processor 304 to perform the algorithms and/or operations described herein when the instructions are executed. However, in some cases, the processor 304 may be a processor specific device (for example, a mobile terminal or a fixed computing device) configured to employ an embodiment of the present invention by further configuration of the processor 304 by instructions for performing the algorithms and/or operations described herein. The processor 304 may include, among other things, a clock, an arithmetic logic unit (ALU) and logic gates configured to support operation of the processor 304.

In some embodiments, the processor 304 may be configured to provide Internet-of-Things (IoT) related capabilities to users of the system 200 disclosed herein. The IoT related capabilities may in turn be used to provide smart city solutions by providing real time parking updates, big data analysis, and sensor based data collection by using the cloud based mapping platform 106 for providing navigation and parking recommendation services. In some embodiments, the mapping platform 106 may be configured to provide an environment for development of parking strategy recommendation solutions for navigation systems in accordance with the embodiments disclosed herein. The environment may be accessed using the user interface module 308 of the mapping platform 106 disclosed herein. The user interface module 316 may provide an interface for accessing various features and data stored in the mapping platform 106.

In some embodiments, the mapping platform 106 may be configured to provide a repository of algorithms for implementing a plurality of location based services for navigation systems. For example, the mapping platform 106 may include algorithms related to geocoding, routing (multimodal, intermodal, and unimodal), machine learning in location based solutions, natural language processing algorithms, artificial intelligence algorithms, parking prediction algorithms, parking time prediction algorithms, and the like. The mapping platform 106 may employ, for example, hierarchical clustering, k-means algorithm (centroid models), DBSCAN algorithm, density based OPTICS algorithm and graph-based models. The data for different modules of the mapping platform 106 may be collected using a plurality of technologies including but not limited to drones, sensors, connected cars, cameras, probes, chipsets and the like. The collected data may be processed by the processor to generate parking recommendations according to the embodiments disclosed herein. As noted above, the mapping platform 106 may be embodied by the processing component 110. However, in some embodiments, the mapping platform 106 may be embodied as a chip or chip set. In other words, the mapping platform 106 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The mapping platform 106 may therefore, in some cases, be configured to implement an example embodiment of the present invention on a single “system on a chip.” As such, in some cases, a chip or chipset may constitute a means for performing one or more operations for providing the functionalities described herein.

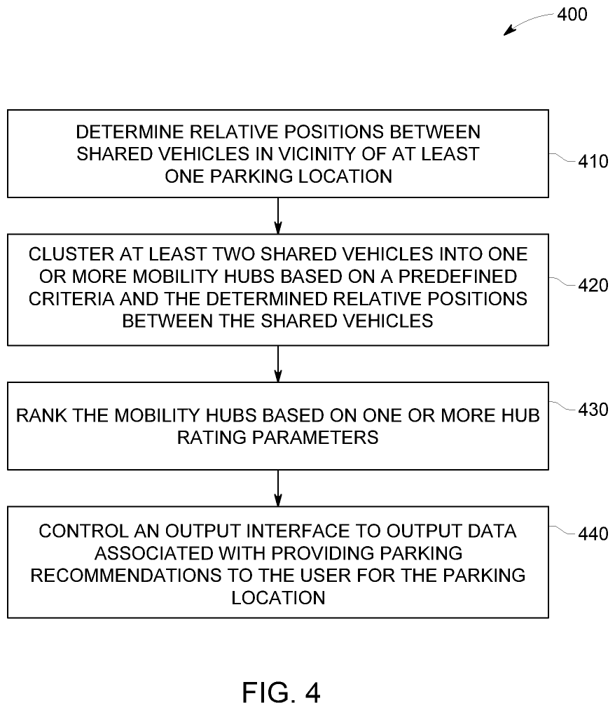

The user interface 206 of the user equipment 102 may in turn be in communication with the processor 304 to provide output to the user and, in some embodiments, to receive an indication of a user input. In some example embodiments, the system 200 may include a user interface 206 that communicates with the processor 304 and displays input and/or output of the mapping platform 106. As such, the user interface 206 may include a display and, in some embodiments, may also include a keyboard, a mouse, a joystick, a touch screen, touch areas, soft keys, one or more microphones, a plurality of speakers, or other input/output mechanisms. In one embodiment, the processor 304 may comprise user interface circuitry configured to control at least some functions of one or more user interface elements such as a display and, in some embodiments, a plurality of speakers, a ringer, one or more microphones and/or the like. The processor 304 and/or user interface circuitry comprising the processor 304 may be configured to control one or more functions of one or more user interface elements through computer program instructions (for example, software and/or firmware) stored on a memory accessible to the processor 304 (for example, memory device 310, and/or the like). In some example embodiments, the processor 304 may be configured to provide a method for providing parking recommendations to a user as will be discussed in conjunction with FIG. 4 as below.

FIG. 4 exemplarily illustrates a method for providing parking recommendations to a user, in accordance with an example embodiment. It will be understood that each block of a flow diagram 400 of the method may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 314 of an apparatus, such as the user equipment 102, or the mapping platform 106, employing an embodiment of the present invention and executed by a processor 304 of the apparatus. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory 314 that may direct a computer or other programmable apparatus to function in a particular manner, such that the instructions stored in the computer-readable memory 314 produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram 400 support combinations of means for performing the specified functions and combinations of operations for performing the specified functions for performing the specified functions. It will also be understood that one or more blocks of the flow diagram 400, and combinations of blocks in the flow diagram 400, can be implemented by special purpose hardware-based computer systems which perform the specified functions, or combinations of special purpose hardware and computer instructions. A method illustrated by the flow diagram 400 of FIG. 4 for providing parking recommendations to a user includes, at 410, determining relative positions between shared vehicles in vicinity of at least one parking location and, at 420, clustering at least two shared vehicles into one or more mobility hubs based on a predefined criteria and the determined relative positions between the shared vehicles as disclosed in the detailed description of FIG. 3. The predefined criteria can be personalized criteria, that is, user preferences or generalized criteria. On-street parking spots and/or off-street parking spots may be used in the creation of the mobility hubs as the on-street parking spots and the off-street parking spots represent locations where the user may be allowed to park a shared vehicle or a personal vehicle and continue towards the destination with another shared vehicle if available. The method may further include, at 430, ranking the mobility hubs based on one or more hub rating parameters and, at 440 controlling an output interface, that is, the user interface 206, to output parking recommendation data to the user as disclosed in the detailed description of FIG. 3. The method may further include computing, by the processor 304, one or more intermodal navigation routes between the ranked mobility hubs and a destination of the user based on the parking recommendation data and rendering, by the processor 304, the computed intermodal navigation routes on the output interface, that is, the user interface 206, for providing navigation assistance to the user for navigating towards his/her destination.

In an example embodiment, a system for performing the method of FIG. 4 above may comprise a processor (e.g. the processor 304) configured to perform some or each of the operations (410-440) described above. The processor may, for example, be configured to perform the operations (410-440) by performing hardware implemented logical functions, executing stored instructions, or executing algorithms for performing each of the operations. Alternatively, the system may comprise means for performing each of the operations described above. In this regard, according to an example embodiment, examples of means for performing operations 410-440 may comprise, for example, the processor 304 and/or a device or circuit for executing instructions or executing an algorithm for processing information as described above.

The data inputted to the mapping platform 106, for example, the sensor data, is transformed, processed, and executed upon by the mapping platform 106 to determine relative positions of the shared vehicles and to provide parking recommendations to a user of a vehicle. The sensor data, that is, the location data from the different sensors installed in the user equipment 102 or the vehicle 202 may be converted to units and ranges compatible with the mapping platform 106, to accurately provide parking recommendations. The user preferences input by the user in natural language to the mapping platform 106 are interpreted and processed by the mapping platform 106 for clustering the shared vehicles into mobility hubs.

On implementing the method disclosed herein, the end result generated by the mapping platform 106 is a tangible determination of parking recommendations. The mapping platform 106 generates parking recommendations for parking the vehicle 202 at a parking location in the vicinity of one or more mobility hubs. The parking recommendations allow parking of a personal vehicle or a shared vehicle and accessing another shared vehicle from the parking location. In this way, the parking recommendations provided around the mobility hubs provide new alternatives for users to reach their destinations and thus, may increase user base of an existing shared vehicle service provider. The parking recommendations include data related to parking options available at a parking location, estimated time of parking at the available parking location, and/or availability of at least one shared vehicle in the mobility hubs, etc. The parking options available at the parking spots are also presented to the user of the vehicle which allows the user to decide proactively whether to park at the available parking spot or not to park at the available parking spot. The parking recommendations assist in parking of shared vehicles or personal vehicles in vicinity of mobility hubs avoiding congestion in finding a parking location, wastage of time of the users, and pollution. The mapping platform 106 ranks the mobility hubs based on various hub rating parameters, such as, a likelihood of finding at least one parking location in proximity of the mobility hubs, a distance between at least one parking location and the mobility hubs, an estimation of time of arrival at a destination of the user, etc. The ranking of the mobility hubs assists in improving infrastructure at the mobility hubs to cater to needs of different users of shared vehicles, and fosters competition between service providers, such as, hotels, retail outlets, etc., in and around the mobility hubs. The mapping platform 106 also computes one or more intermodal navigation routes between the ranked mobility hubs and a destination of the user using shared vehicles available at the mobility hubs and personal vehicles. In some embodiments, the mapping platform 106 determines the intermodal navigation routes dynamically based on the real-time traffic data, availability of parking spots (off-street parking spot and/or on-street parking spot) around the mobility hubs en-route the destination of the user, service boundaries defined by the shared vehicle service providers, etc. The parking recommendations may be suitably rendered on the output interface, for example, the user interface 206 to enable the user to take advantage of the improvements in accessing parking spots and intermodal navigation assistance as provided by the method discussed herein.

The method disclosed herein provides an improvement in computer related technology related to parking assistance as follows: The mapping platform 106 determines relative positions between different shared vehicles in a geographical region and clusters the shared vehicles in one or more mobility hubs based on the relative positions between them. The mobility hubs integrate different modes of transportation by providing multi-modal supportive infrastructure. The multi-modal supportive infrastructure include parking bays or navigation to parking locations for the different shared vehicles around the mobility hubs, shelters at the mobility hubs, real-time traffic data around the mobility hub, charging stations for electric vehicles at the mobility hub, kiosks providing information regarding retail outlets around the mobility hub, etc. The clustering of the shared vehicles into the mobility hubs is based on the personal attributes and preferences of the users of the shared vehicles. Due to the personalization of the mobility hubs, idle time of the shared vehicles in the mobility hubs is minimized and the mobility hubs contribute to the profits of the shared vehicle service providers. The clustering of the shared vehicles into mobility hubs is also based on the service areas defined by the shared vehicle service provider. The mapping platform 106 ranks the mobility hubs and the highest ranked mobility hub satisfies all or almost all preferences of the users. The mapping platform 106 computes intermodal navigation routes from a mobility hub to a destination of the user. Using the rankings, the mapping platform 106 intelligently selects a mobility hub with a higher rank towards the destination of the user as a part of the computation of the intermodal navigation routes. The mapping platform 106 considers service boundary of service areas defined by shared vehicle service providers while providing parking recommendation and intermodal navigation routes. Some examples of the different zones in the service area are EV only zone, diesel exclusion zone, no parking zone, no car zone, park zone, etc. In some embodiments, the mapping platform 106 lists the ranks of the mobility hubs and intelligently suggests different intermodal navigation routes between the mobility hubs towards the destination of the user. The user is allowed to select the best suitable intermodal navigation route from the list. The mobility hubs may also include autonomous vehicles along with the shared vehicles driven by the users. The mapping platform 106 dynamically updates the clusters based on the relative positions of the shared vehicles. The system employing the mapping platform 106 finds application in general parking zone management in cities, traffic management in service areas catered by one or more shared vehicle service providers, and autonomous vehicle parking.

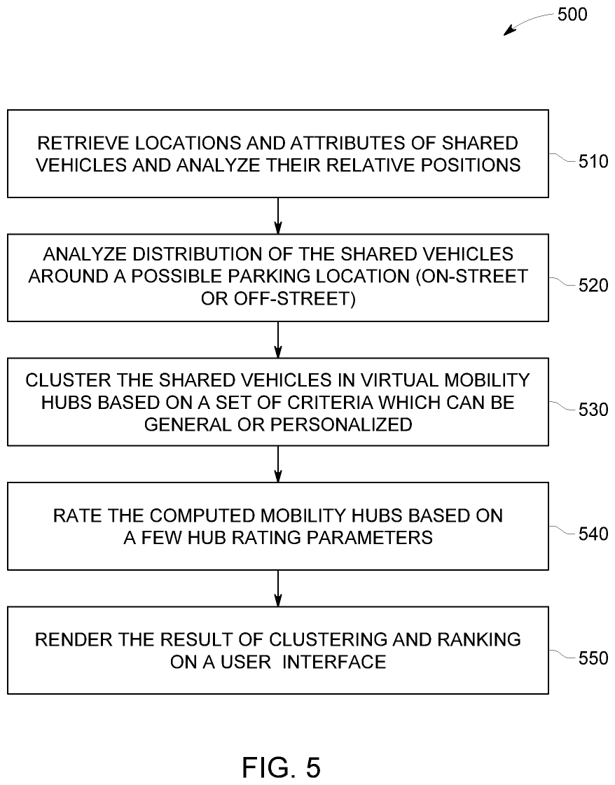

FIG. 5 exemplarily illustrates a flow diagram 500 of a method comprising steps for clustering shared vehicles into one or more mobility hubs, in accordance with an example embodiment. At step 510, the mapping platform 106 retrieves locations and attributes of shared vehicles from the shared vehicle service providers as disclosed in the detailed description of FIG. 2 and analyzes relative positions between them. The mapping platform 106 computes difference of location measurements between pairs of shared vehicles. The mapping platform 106, at step 520, may analyze distribution of the shared vehicles around a possible parking location based on the analyzed relative positions and generate a distribution profile of the shared vehicles. The parking location may be an on-street parking location or an off-street parking location. The mapping platform 106 may further, at step 530, cluster the shared vehicles into virtual mobility hubs based on a set of predefined criteria as disclosed in the detailed description of FIG. 3. The predefined criteria can be general criteria applicable to all users of the shared vehicles or can be personalized criteria applicable to a single user of the shared vehicles as disclosed in detailed description of FIG. 3. At step 540, the mapping platform 106 may rate the computed mobility hubs based on a few hub rating parameters as disclosed in the detailed description of FIG. 3 and at step 550, the mapping platform 106 may render the result of clustering, that is, the location of the mobility hubs and the ranking associated with each of the mobility hubs on a user interface 206 as a map, a list, etc. In an embodiment, the mapping platform 106 may filter the shared vehicles based on user preferences and the mapping platform 106 may fetch locations of the filtered shared vehicles. Based on relative positions of the filtered shared vehicles, the mapping platform 106 clusters the filtered shared vehicles into one or more mobility hubs and ranks the mobility hubs.

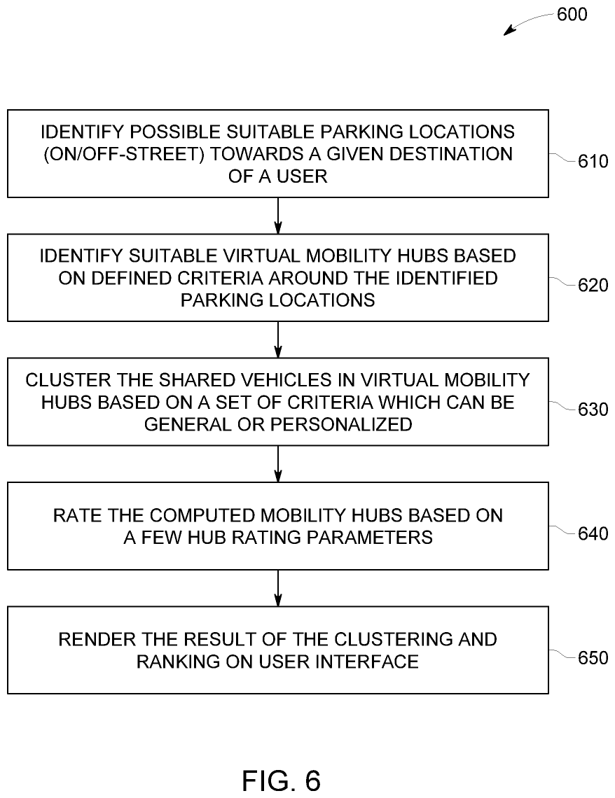

FIG. 6 exemplarily illustrates a flow diagram 600 of a method comprising steps for clustering shared vehicles into one or more mobility hubs based on parking locations, in accordance with an example embodiment. As exemplarily illustrated, at step 610, the mapping platform 106 identifies possible suitable parking locations towards a destination of a user. At step 620, the mapping platform 106, further identifies suitable existing virtual mobility hubs based on the predefined criteria around the identified parking locations. At step 630, the mapping platform 106 may cluster the shared vehicles into the existing virtual mobility hubs or create new virtual mobility hubs based on a set of predefined criteria (general criteria or personalized criteria). At step 640, the mapping platform 106 rates the computed mobility hubs based on a few hub rating parameters as disclosed in the detailed description of FIG. 3 and at step 650, the mapping platform 106 may render the result of clustering, that is, the location of the mobility hubs and the ranking associated with each of the mobility hubs on the user interface 206 as a map, a list, etc.

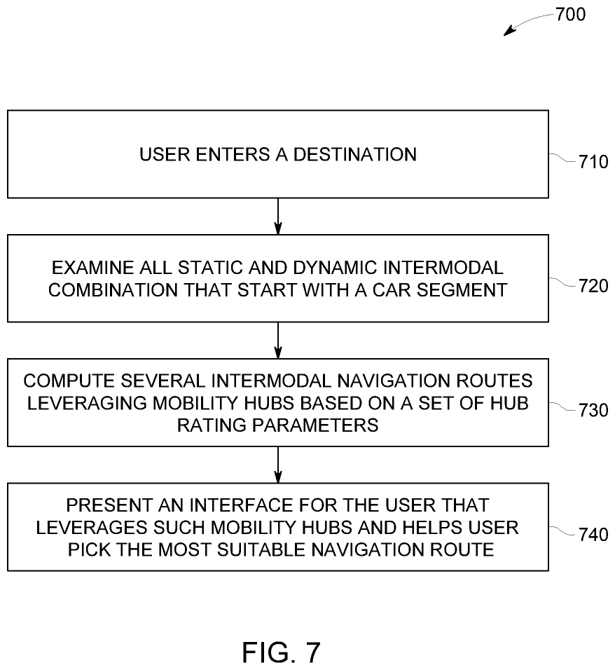

FIG. 7 exemplarily illustrates a flow diagram 700 of a method comprising steps for suggesting intermodal navigation routes to a destination of user, in accordance with an example embodiment. As exemplarily illustrated, at step 710, a user of a personal vehicle or a shared vehicle inputs a destination in the user interface 206. Consider, for example, the user is at a starting point and the user uses a personal vehicle, such as, a car. At step 720, the mapping platform 106 may examine static and dynamic intermodal navigation routes to the destination of the user from the starting point. The static intermodal navigation routes may refer to navigation routes that are calculated once at the starting point, using the mobility hub information available at the point of route calculation, and the dynamic intermodal navigation routes may refer to navigation routes that are recalculated or adjusted while the vehicle 202 is being driven, in view of updates to the mobility hub information. The determination of the dynamic intermodal navigation routes allows for navigating to a mobility hub existing at the point of route calculation and altering the intermodal navigation route in response to a change in the mobility hub information, such as change in the ranking of the mobility hub, newly formed mobility hub(s), newly unavailable mobility hub(s), unavailability of a preferred vehicle at the mobility hub, etc.

In some embodiments where the personal vehicle is a car, the mapping platform 106 may examine the intermodal navigation routes with a car segment from the starting point initially. The mapping platform 106 may compute the intermodal navigation routes based on real-time traffic data, conditions existent at the mobility hubs ahead, etc. At step 730, the mapping platform 106 may compute several intermodal navigation routes leveraging previously formed mobility hubs based on a set of hub rating parameters. At step 740, the mapping platform 106 may present a user interface 206 to the user who leverages such mobility hubs and the mapping platform 106 helps the user pick the most suitable intermodal navigation route to the destination.

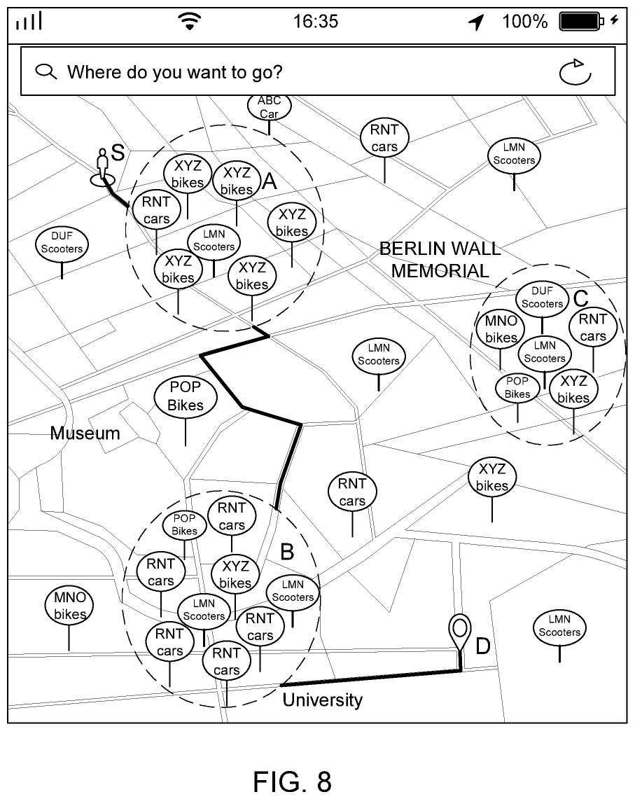

FIG. 8 illustrates a user interface 206 showing an intermodal navigation route computed by the mapping platform 106 to a destination of a user via mobility hubs comprising clustered shared vehicles, in accordance with an example embodiment. Consider an example where a user starts from a starting point S and intends to reach a destination D. The user employs the system 200 to navigate from the starting point S to the destination D. The mapping platform 106 of the system 200 may be configured to determine relative positions of shared vehicles operated by different shared vehicle service providers and cluster the shared vehicles into mobility hubs, for example, A, B, and C based on the personalized criteria of the user as exemplarily illustrated. Also, assume the mobility hub C has a lower ranking due higher percentage of faulty shared vehicles compared to the mobility hubs A and B. Consider the user prefers bikes and cars in different segments of the route towards the destination and the user prefers cars from RNT cars service provider over ABC cars service providers. Considering the user also prefers bikes over scooters and XYZ bikes service providers over POP bikes service providers, the mapping platform 106, based on the personalized criteria of the user and similar users, may cluster more bikes of XYZ bikes service provider in the mobility hub A. The mapping platform 106 may not include the car of ABC car service provider in mobility hub even if the car of ABC car service provider is available in the vicinity of the mobility hub A considering the preference of the user. The mapping platform 106 guides the user to use his/her car from the starting point S till a parking location in the vicinity of the mobility hub A. The mapping platform 106 provides parking recommendations to park the car in the vicinity of the mobility hub A. The user is allowed to make a reservation of a bike of, for example, XYZ bikes service provider at the mobility hub A. The mapping platform 106, based on dynamic conditions towards the destination of the users and in the vicinity of the mobility hubs A, B, and C, computes a navigation route using the bike from XYZ bikes service provider towards the mobility hub B, avoiding commute towards the mobility hub C based on the ranking of the mobility hub C. In the vicinity of the mobility hub B, the mapping platform 106 provides parking recommendations to park the bike. At the mobility hub B, the user is allowed to make a reservation for a car from RNT cars service providers. From the mobility hub B, the mapping platform 106 may suggest a static and a dynamic navigation route towards the destination D based on traffic conditions enroute to the destination D. The intermodal navigation route suggested by the mapping platform 106 reduces travel time of the user to the destination D from the starting point S using the shared vehicles at mobility hubs A and B by avoiding traffic and wastage of time in parking of the shared vehicles en route.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for providing parking recommendations to a user, the system comprising:
at least one non-transitory memory configured to store computer program code instructions; and
at least one processor configured to execute the computer program code instructions to:
determine relative positions between a plurality of shared vehicles in vicinity of at least one parking location;
cluster at least two shared vehicles from the plurality of shared vehicles into one or more mobility hubs based on a predefined criteria and the determined relative positions between the plurality of shared vehicles;
rank the one or more mobility hubs based on one or more hub rating parameters; and
control an output interface to output parking recommendation data to the user for the at least one parking location, based on the ranking of the one or more mobility hubs.

2. The system of claim 1, wherein the processor is further configured to identify the at least one parking location along a route to a destination of the user.

3. The system of claim 2, wherein the processor is further configured to cluster at least two shared vehicles from the plurality of shared vehicles in vicinity of the at least one identified parking location into the one or more mobility hubs based on service boundaries defined by shared vehicle service providers.

4. The system of claim 1, wherein the processor is further configured to:
compute one or more intermodal navigation routes between the ranked one or more mobility hubs and a destination of the user based on the parking recommendation data; and
render the computed one or more intermodal navigation routes on the output interface to provide navigation assistance to the user for navigating towards the destination.

5. The system of claim 4, wherein each of the one or more intermodal navigation routes is one of static or dynamic.

6. The system of claim 1, wherein parking recommendation data indicates one or more of parking options available at the at least one parking location, estimated time of parking at the available at least one parking location, and availability of at least one shared vehicle in the one or more mobility hubs.

7. The system of claim 1, wherein the predefined criteria comprise one or more of availability of a suitable parking location, availability of one or more bookable shared vehicles, cluster radii of the one or more mobility hubs, user preferences regarding available shared vehicles comprising types and brands of shared vehicles, cleanliness of the shared vehicles, ratings associated with the shared vehicles, fuel level of the shared vehicles, distance to one or more available shared vehicles, and user subscription associated with the one or more shared vehicle service providers

8. The system of claim 1, wherein the hub rating parameters comprise one or more of a likelihood of finding at least one parking location in proximity of the one or more mobility hubs, a distance between the at least one parking location and the one or more mobility hubs, an estimation of time of arrival at a destination of the user, number of alternative shared vehicles available to the user in the one more mobility hubs, matching a type of a shared vehicle in the one or more mobility hubs with a user preferred mode of travel, a risk associated with an expiry of an allotted time of reservation of a shared vehicle in the one or more mobility hubs, and cluster radii of the one or more mobility hubs.

9. The system of claim 1, wherein the processor is further configured to dynamically update the cluster of at least two shared vehicles from the plurality of shared vehicles in vicinity of the at least one parking location into one or more mobility hubs based on the predefined criteria.

10. The system of claim 9, wherein the processor is further configured to dynamically update the rank of each of the one or more dynamically updated mobility hubs based on the hub rating parameters.

11. The system of claim 1, wherein the processor is further configured to render a visualization of the one or more mobility hubs on the output interface as one of a list and location markers in a mapping application.

12. A method for providing parking recommendations to a user, the method comprising:
determining relative positions between a plurality of shared vehicles in vicinity of at least one parking location;
clustering, by a processor, at least two shared from the plurality of shared vehicles into one or more mobility hubs based on a predefined criteria and the determined relative positions between the plurality of shared vehicles;
ranking the one or more mobility hubs, by the processor, based on one or more hub rating parameters; and
controlling an output interface to output parking recommendation data for the at least one parking location, based on the ranking of the one or more mobility hubs.

13. The method of claim 12, wherein the at least one parking location is identified, by the processor, along a route to a destination of the user.

14. The method of claim 13, wherein the clustering, by the processor, of at least two shared vehicles from the plurality of shared vehicles in vicinity of the at least one identified parking location into the one or more mobility hubs is based on service boundaries defined by shared vehicle service providers.

15. The method of claim 12, further comprising:
computing, by the processor, one or more intermodal navigation routes between the ranked one or more mobility hubs and a destination of the user based on the parking recommendation data; and
rendering, by the processor, the computed one or more intermodal navigation routes on the output interface for providing navigation assistance to the user for navigating towards the destination.

16. The method of claim 15, wherein each of the one or more intermodal navigation routes is one of static or dynamic.

17. The method of claim 12, wherein parking recommendation data indicates one or more of parking options available at the at least one parking location, estimated time of parking at the available at least one parking location, and availability of at least one shared vehicle in the one or more mobility hubs.

18. The method of claim 12, wherein the predefined criteria comprise one or more of availability of a suitable parking location, availability of one or more bookable shared vehicles, cluster radii of the one or more mobility hubs, user preferences regarding available shared vehicles comprising types and brands of shared vehicles, cleanliness of the shared vehicles, ratings associated with the shared vehicles, fuel level of the shared vehicles, distance to one or more available shared vehicles, and user subscription associated with the one or more shared vehicle service providers

19. The method of claim 12, wherein the hub rating parameters comprise one or more of a likelihood of finding at least one parking location in proximity of the one or more mobility hubs, a distance between the at least one parking location and the one or more mobility hubs, an estimation of time of arrival at a destination of the user, number of alternative shared vehicles available to the user in the one more mobility hubs, matching a type of a shared vehicle in the one or more mobility hubs with a user preferred mode of travel, a risk associated with an expiry of an allotted time of reservation of a shared vehicle in the one or more mobility hubs, and cluster radii of the one or more mobility hubs.

20. The method of claim 12, further comprising dynamically updating the cluster of at least two shared vehicles from the plurality of shared vehicles in vicinity of the at least one parking location into one or more mobility hubs, by the processor, based on the predefined criteria.

21. The method of claim 20, further comprising dynamically updating the rank of each of the one or more dynamically updated mobility hubs, by the processor, based on the hub rating parameters.

22. The method of claim 12, further comprising rendering a visualization of the one or more mobility hubs, by the processor, on the output interface as one of a list and location markers in a mapping application.

23. A method for creating mobility hubs, the method comprising:
determining relative positions between a plurality of shared vehicles;
determining a distribution profile for the plurality of shared vehicles in vicinity of at least one parking location, based on the relative positions of the plurality of shared vehicles; and
clustering, by a processor, at least two shared vehicles in vicinity of the at least one parking location into one or more mobility hubs based on a predefined criteria and the distribution profile.

24. A computer program product comprising at least one non-transitory computer-readable storage medium having stored thereon computer-executable program code instructions which when executed by a computer, cause the computer to carry out operations for providing parking recommendations to a user, the operations comprising:
determining relative positions between a plurality of shared vehicles in vicinity of at least one parking location;
clustering, by a processor, at least two shared vehicles from the plurality of shared vehicles into one or more mobility hubs based on a predefined criteria and determined relative positions between the plurality of shared vehicles;
ranking of the one or more mobility hubs, by the processor, based on one or more hub rating parameters; and
controlling an output interface to output parking recommendation data for the at least one parking location, based on the ranking of the one or more mobility hubs.
